(19) United States
(12) Patent Application Publication
(10) Pub. No.: US 2025/0334480 A1
(43) Pub. Date: Oct. 30, 2025

(54) Optical Article Inspection Apparatus and Method

(71) Applicant: Transitions Optical, Ltd., Tuam, Co. (IE)

(72) Inventors: Neil Murphy, Castlebar, Co. Mayo (IE); Forrest R. Blackburn, Pickerington, OH (US); Joshua Hazle, Tampa, FL (US); Adam Choros, Pittsburgh, PA (US); Willard Beamer, Palmetto, FL (US); Laura Askew-Crawford, Parrish, FL (US)

(21) Appl. No.: 18/705,294

(22) PCT Filed: Oct. 27, 2021
(86) PCT No.: PCT/EP2021/079816

§ 371 Date: Apr. 26, 2024

(51) Int. Cl. G01M 11/02

(52) U.S. Cl. CPC G01M 11/0214

(57) ABSTRACT

An inspection apparatus configured for inspecting optical articles includes an inspection chamber having an inspection station and a holding chamber having an indexable holding platform with a plurality of holding slots each configured for receiving a holder adapted for securing the optical article. The indexable holding platform is configured to index a selected holder into an inspection position. The inspection apparatus further includes a gripper mechanism configured for transferring the selected holder from the inspection position to the inspection chamber. A method of inspecting an optical article using an inspection apparatus is also disclosed.

### CROSS REFERENCE TO RELATED APPLICATION

This application is the United States national phase of International Patent Application No. PCT/EP21/79816 filed Oct. 27, 2021, the disclosure of which is hereby incorporated by reference in its entirety.

### BACKGROUND OF THE INVENTION

### Field of the Invention

The present disclosure relates generally to an inspection apparatus for inspecting an optical article and a method for inspecting an optical article using the inspection apparatus, and, in particular, to an automated inspection apparatus for inspecting one or more characteristics of a plurality of optical articles and a method for inspecting a plurality of optical articles using the inspection apparatus.

### Description of Related Art

During manufacture of optical articles, such as contact lenses or eyeglass lenses, it is desirable to perform one or more inspection processes. Such inspection processes may be configured for inspecting one or more characteristics of the optical article in order to maintain product consistency and quality. For example, the inspection process may be configured for determining the presence of defects.

Manual inspection of optical articles is expensive, time consuming, and is likely to produce inconsistent results. Automated inspection devices have been developed to automate the inspection processes and eliminate the need for manual inspection. With many automated inspection devices, a user must manually load and unload lenses one at a time into the inspection device. During the automated inspection process, each optical article is immersed in a liquid, such as a saline solution, and is inspected for defects. The automated inspection process may take up to 20 minutes, during which no additional lenses can be loaded into or unloaded from the inspection device. While conventional automated inspection devices have improved the quality of the inspection process, such inspection devices are not configured for a batch inspection process where a plurality of optical articles are automatically loaded into the automated inspection device and unloaded therefrom after completion of the one or more inspection processes on each of the plurality of optical articles.

Accordingly, there is a need in the art to provide an automated loading and unloading of optical articles into and out of the inspection device.

### SUMMARY OF THE INVENTION

In accordance with some examples or aspects of the present disclosure, provided is an inspection apparatus configured for inspecting optical articles. The inspection apparatus may have an inspection chamber including an inspection station, and a holding chamber having an indexable holding platform with a plurality of holding slots each configured for receiving a holder adapted for securing the optical article. The indexable holding platform may be configured to index a selected holder into an inspection position. The inspection apparatus further may include a gripper mechanism configured for transferring the selected holder from the inspection position to the inspection chamber.

In accordance with some examples or aspects of the present disclosure, each holder may include a holder body having a lens receiving portion, a clamping lid connected to the holder body and movable between a closed position configured for clamping the optical article and an open position, and a first connection member configured for securing the holder body to the holding slot of the indexable holding platform. The first connection member may be one of a first magnet and a first magnetically attractable material that is configured for magnetically interacting with a corresponding one of a second magnetically attractable material and a second magnet on the holding slot of the indexable holding platform. Each holder may include a second connection member configured for connecting the holder body to the gripper mechanism. Each holder further may include an identification tag.

In accordance with some examples or aspects of the present disclosure, the indexable holding platform may be a rotary magazine that includes a plurality of distinct circumferential positions each having a holding slot. Each holding slot of the holding mechanism may include a baffle positioned relative to the holder such that the baffle covers the optical article.

In accordance with some examples or aspects of the present disclosure, the gripper mechanism may be linearly movable between a first position corresponding to a location of the inspection position of the indexable holding platform and a second position corresponding to a location of the inspection station. The inspection station may include at least one viewing port and the inspection chamber may have a scalloped sidewall.

In accordance with some examples or aspects of the present disclosure, the inspection apparatus further may include an auxiliary chamber having: a pump configured for circulating fluid within the holding chamber and within a temperature control circuit of the inspection apparatus, a filter configured for filtering the fluid, and a temperature controller configured for controlling a temperature of the fluid.

In accordance with some examples or aspects of the present disclosure, the holding chamber may be in fluid communication with the inspection chamber. The holding chamber may be optically isolated from the inspection chamber.

In accordance with some examples or aspects of the present disclosure, provided is a method of inspecting an optical article using an inspection apparatus. The method may include rotating the indexable holding platform having a plurality of holding slots each configured for receiving a holder adapter for securing the optical article until a selected holder is indexed to an inspection position. The method further may include moving a gripping mechanism to the inspection position to grip the selected holder, and moving the gripping mechanism from the inspection position to an inspection station configured for inspecting the optical article.

In accordance with some examples or aspects of the present disclosure, the method further may include returning the selected holder to the indexable holding platform after inspecting the optical article and rotating the indexable holding platform until a next selected holder is indexed to the inspection position. The method further may include maintaining a temperature of a fluid immersing the holders at a predetermined temperature.

An inspection apparatus for inspecting optical articles and a method of inspecting optical articles using the inspection apparatus may be characterized by one or more of the following aspects.

In a first aspect, an inspection apparatus configured for inspecting optical articles may have an inspection chamber including an inspection station, a holding chamber having an indexable holding platform with a plurality of holding slots each configured for receiving a holder adapted for securing the optical article, the indexable holding platform configured to index a selected holder into an inspection position, and a gripper mechanism configured for transferring the selected holder from the inspection position to the inspection chamber.

In a second aspect, in the inspection apparatus in accordance with the first aspect, each holder may include a holder body having a lens receiving portion, a clamping lid connected to the holder body and movable between a closed position configured for clamping the optical article and an open position, and a first connection member configured for securing the holder body to the holding slot of the indexable holding platform.

In a third aspect, in the inspection apparatus in accordance with the first aspect or the second aspect, the first connection member may be one of a first magnet and a first magnetically attractable material that is configured for magnetically interacting with a corresponding one of a second magnetically attractable material and a second magnet on the holding slot of the indexable holding platform.

In a fourth aspect, in the inspection apparatus in accordance with the third aspect, each holder may include a second connection member configured for connecting the holder body to the gripper mechanism.

In a fifth aspect, in the inspection apparatus in accordance with any of the first aspect to the fourth aspect, each holder further may include an identification tag. The identification tag may be unique to each holder.

In a sixth aspect, in the inspection apparatus in accordance with any of the first aspect to the fifth aspect, the indexable holding platform may be a rotary magazine that includes a plurality of distinct circumferential positions each having a holding slot.

In a seventh aspect, in the inspection apparatus in accordance with any of the first aspect to the sixth aspect, each holding slot of the holding mechanism may include a baffle positioned relative to the holder such that the baffle covers the optical article.

In an eighth aspect, in the inspection apparatus in accordance with any of the first aspect to the seventh aspect, the gripper mechanism may be linearly movable between a first position corresponding to a location of the inspection position of the indexable holding platform and a second position corresponding to a location of the inspection station.

In a ninth aspect, in the inspection apparatus in accordance with any of the first aspect to the eighth aspect, the inspection station may include at least one viewing port and the inspection chamber may have a scalloped sidewall.

In a tenth aspect, in the inspection apparatus in accordance with any of the first aspect to the ninth aspect, the inspection apparatus further may include an auxiliary chamber having: a pump configured for circulating fluid within the holding chamber and within a temperature control circuit of the inspection apparatus; a filter configured for filtering the fluid; and a temperature controller configured for controlling a temperature of the fluid.

In an eleventh aspect, in the inspection apparatus in accordance with any of the first aspect to the tenth aspect, the holding chamber may be in fluid communication with the inspection chamber.

In a twelfth aspect, in the inspection apparatus in accordance with any of the first aspect to the eleventh aspect, the holding chamber may be optically isolated from the inspection chamber.

In a thirteenth aspect, a method of inspecting an optical article using an inspection apparatus may include rotating the indexable holding platform having a plurality of holding slots each configured for receiving a holder adapter for securing the optical article until a selected holder is indexed to an inspection position; moving a gripping mechanism to the inspection position to grip the selected holder; and moving the gripping mechanism from the inspection position to an inspection station configured for inspecting the optical article.

In a fourteenth aspect, in the inspection apparatus in accordance with the first aspect, the method may further include returning the selected holder to the indexable holding platform after inspecting the optical article and rotating the indexable holding platform until a next selected holder is indexed to the inspection position.

In a fifteenth aspect, in the method in accordance with the thirteenth or fourteenth aspect, the method further may include maintaining a temperature of a fluid immersing the holders at a predetermined temperature.

The features that characterize the present disclosure are pointed out with particularity in the claims, which are annexed to and form a part of this disclosure. These and other features of the disclosure, its operating advantages, and the specific objects obtained by its use will be more fully understood from the following detailed description in which non-limiting examples of the disclosure are illustrated and described.

### BRIEF DESCRIPTION OF THE DRAWINGS

FIG. 1 is a top perspective view of an inspection apparatus for inspecting a plurality of optical articles in accordance with some examples or aspects of the present disclosure;

FIG. 2A is a bottom plan view of a first portion of a holding portion configured for use with the inspection apparatus of FIG. 1;

FIG. 2B is a top view of the holding portion shown in FIG. 2A;

FIG. 3 is a top perspective view of a holding platform configured for use with the inspection apparatus of FIG. 1;

FIG. 4A is a detailed top perspective view of a front portion of a holding slot of the inspection platform shown in FIG. 3 and a holder positioned in the holding slot;

FIG. 4B is a detailed top perspective view of a rear portion of the holding slot and holder shown in FIG. 4A;

FIG. 5A is a top perspective view of a holder for holding an optical article in accordance with some examples or aspects of the present disclosure, the holder configured for use with the holding platform shown in FIG. 3;

FIG. 5B is an exploded top perspective view of the holder shown in FIG. 5A;

FIG. 6 is a top perspective view of a gripper mechanism in accordance with some examples or aspects of the present disclosure, the gripper mechanism configured for use with the inspection apparatus shown in FIG. 1;

FIG. 7A is a detailed top perspective view of an inspection portion configured for use with the inspection apparatus of FIG. 1;

FIG. 7B is a top view of the inspection chamber shown in FIG. 7A;

FIG. 7C is a detailed top perspective view of the inspection portion of FIG. 7A with a cover removed from an upper portion of the inspection chamber;

FIG. 8 is a top view of an auxiliary portion configured for use with the inspection apparatus of FIG. 1;

FIG. 9 is a flow chart of a method for inspecting optical articles in accordance with some examples or aspects of the present disclosure.

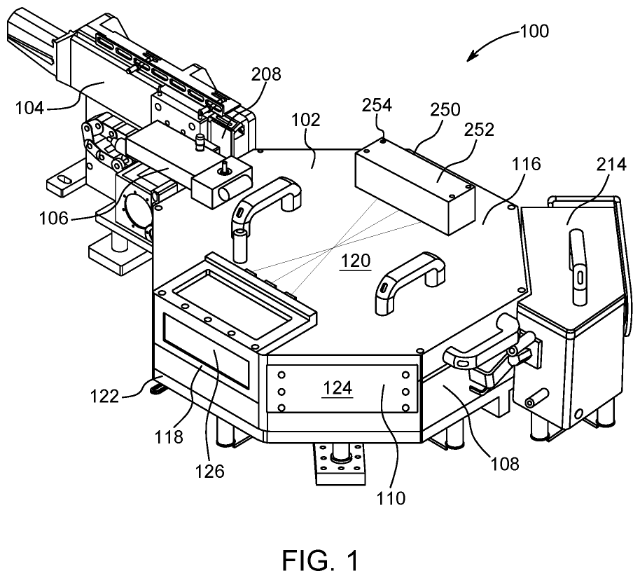

In FIGS. 1-9, like characters refer to the same components and elements, as the case may be, unless otherwise stated.

### DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

As used herein, the term “optical” means pertaining to or associated with light and/or vision. For example, according to various non-limiting aspects disclosed herein, the optical element, article or device can be chosen from ophthalmic elements, articles, and devices, display elements, articles, and devices, windows, and mirrors.

As used herein, the term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, optical articles, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the terms “visible light” or “visible radiation” means electromagnetic radiation having a wavelength in the range of 380 nm to 780 nm.

The discussion of various examples or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various examples and aspects described herein.

As used herein, the terms “communication” and “communicate” may refer to the reception, receipt, transmission, transfer, provision, and/or the like, of information (e.g., data, signals, messages, instructions, commands, and/or the like).

As used herein, a “graphical user interface” or “GUI” refers to a generated display with which a user may interact, either directly or indirectly (e.g., through a button, keyboard, mouse, touchscreen etc.).

As used herein, the term “inspection”, when used in reference to an optical article, refers to at least one of a quantitative, qualitative, or performance measurement of at least one characteristic of the optical article.

The disclosure comprises, consists of, or consists essentially of, the following examples or aspects, in any combination. Various examples or aspects of the disclosure are illustrated in separate drawing figures. However, it is to be understood that this is simply for case of illustration and discussion. In the practice of the disclosure, one or more examples or aspects shown in one drawing figure can be combined with one or more examples or aspects shown in one or more of the other drawing figures.

With reference to FIG. 1, an inspection apparatus 100 is shown in accordance with some examples or aspects of the present disclosure. The inspection apparatus 100 may be configured for inspecting optical articles, such as an automated inspection of a plurality of optical articles. The inspection apparatus 100 generally includes a holding station 102 configured for holding a plurality of optical articles, an inspection station 104 configured for inspecting the optical articles, and a transfer station 106 configured for transferring individual optical articles between the holding station 102 to the inspection station 104 during an automated inspection process.

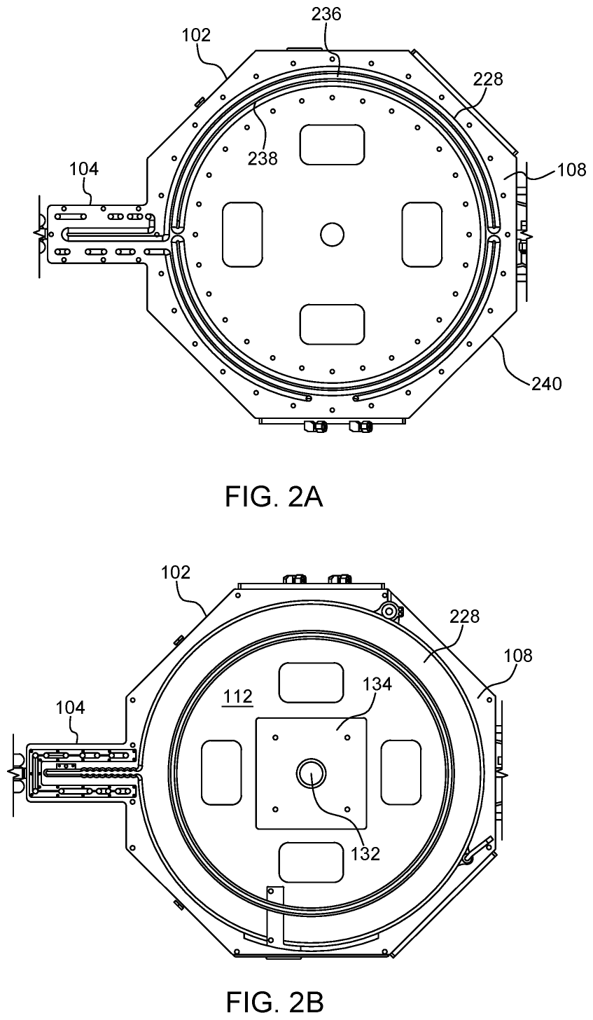

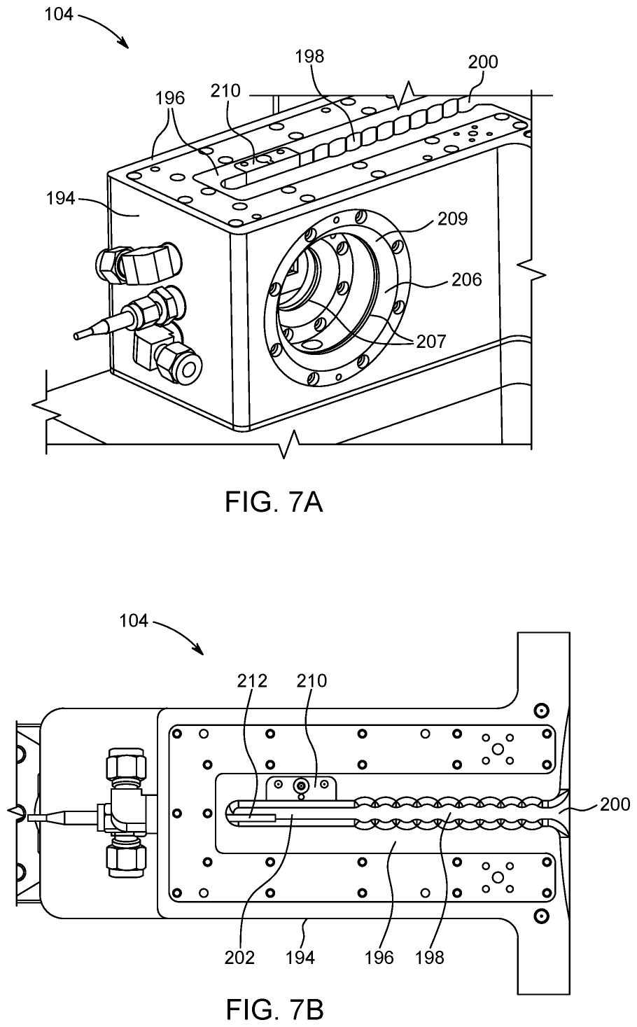

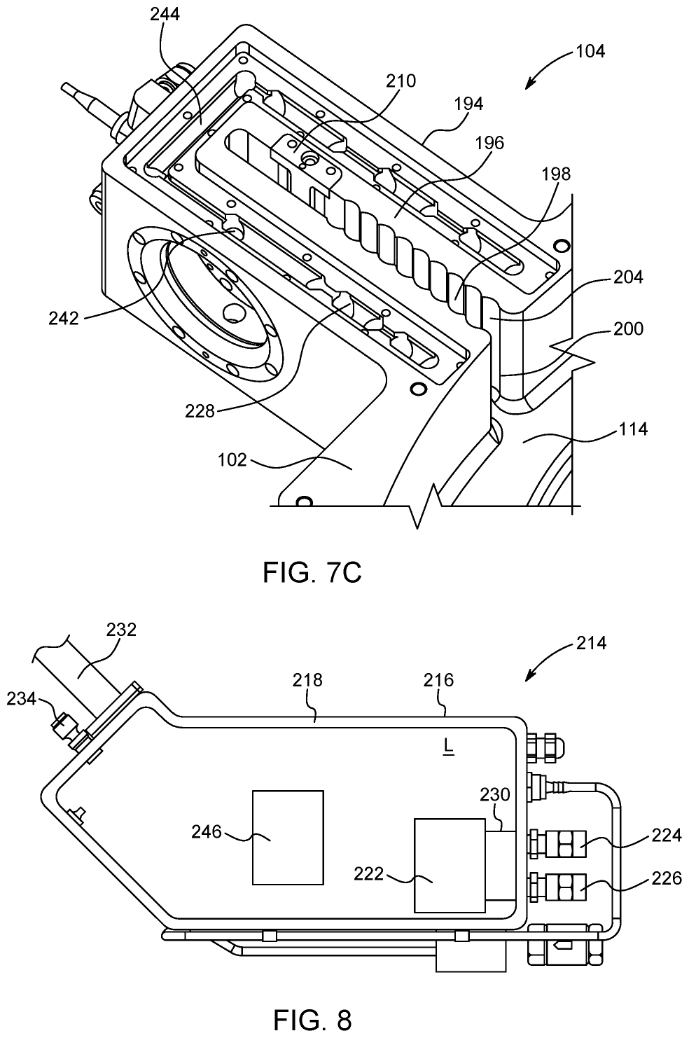

With continued reference to FIG. 1, the holding station 102 includes a housing 108 having a sidewall 110 connected to a bottom wall 112 (shown in FIG. 2B) to define a holding chamber 114 (shown in FIG. 7C). A lid 116 is configured for removably engaging an upper end of the sidewall 110 opposite the bottom wall 112 to fully enclose the holding chamber 114. In some examples or aspects, one or more doors 118 may be provided on the sidewall 110 to provide access to the holding chamber 114. In some examples or aspects, the one or more doors 118 may be provided on the lid 116, or on the sidewall 110 and the lid 116. The housing 102 may be of any suitable rigid material, such as metal, plastic, or a combination thereof.

With continued reference to FIG. 1, the housing 108 includes a plurality of sides, including a top side 120 defined by the lid 116, a bottom side 122 defined by the bottom wall 112, and one or more vertical walls 124 defining the sidewall 110. In some examples or aspects, the housing 108 is monolithically formed as a single, integral part. In other examples or aspects, the housing 108 is formed from a plurality of discrete parts that are removably or non-removably combined together. The holding chamber 114 defined by the plurality of sides of the housing 108 is desirably fluid tight to prevent leakage of fluid therefrom. In some examples or aspects, the holding chamber 114 is configured for being at least partially filled with liquid, such as water or a saline solution. While the housing 108 shown in FIG. 1 has a substantially octagonal shape, the housing 102 may have any other shape.

In some examples or aspects, at least a portion of the housing 108 may be transparent to allow viewing of the holding chamber 114 from the outside of the housing 108 through at least a portion of the sidewall 110 and/or the lid 116. For example, at least a portion of the sidewall 110 and/or the lid 116 may have a viewing window 126. In some examples or aspects, the viewing window 126 may be provided on the door 118 that is provided on at least one of the sidewall 110 and the lid 116. The viewing window 126 may be covered by a transparent cover made of plastic or glass. As used herein, “transparent” means permitting visible light to pass through without diffusing or scattering the light. In other examples or aspects, the viewing window 126 may be opaque to prevent transmission of visible light from outside of the housing 108 into the holding chamber 114.

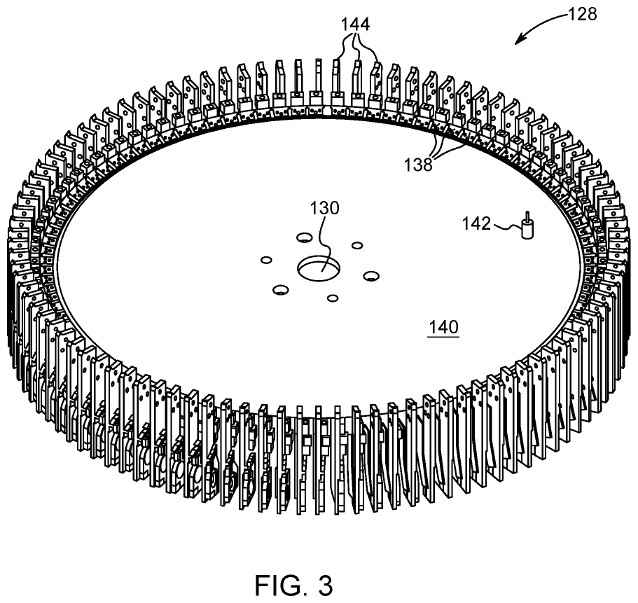

With reference to FIG. 3, a holding platform 128 is shown in accordance with some embodiments or aspects. The holding platform 128 may be configured for use with the holding station 102 of the inspection apparatus 100 (shown in FIG. 1). For example, the holding platform 128 may be configured for being received within the holding chamber 114 of the holding station 102 and for holding a plurality of optical articles, as described herein. In some examples or aspects, the holding platform 128 may have a substantially circular shape.

With continued reference to FIG. 3, the holding platform 128 may be rotatably supported within the holding chamber 114 of the inspection station 102. In some examples or aspects, the holding platform 128 has a central opening 130 that is configured for receiving a rotating shaft 132 of a drive mechanism 134 (shown in FIG. 2B). The rotating shaft 132 may be configured for engaging an inner surface of the central opening 130, such as via splines, a key, or other engagement mechanism, such that rotation of the rotating shaft 132 about its rotational axis 136 causes a corresponding rotation of the holding platform 128. Operation of the drive mechanism 134 may be controlled such that a rotational position of the holding platform 128 can be accurately determined, as discussed herein.

In some examples or aspects, the holding platform 128 may be an indexable holding platform. For example, the holding platform 128 may be a rotary magazine that can be indexed into any one of a plurality of distinct circumferential positions. One or more position determining features 142 may be provided on the holding platform 128 to facilitate determining a rotational position of the holding platform 128. The one or more position determining features 142 may be configured for interacting with a sensor (not shown) configured for determining the rotational position of the holding platform 128. In further examples or aspects, the one or more position determining features 142 may be configured for confirmation of position, validation of position, verification of position accuracy, and start-stop sequencing of the holding platform 128.

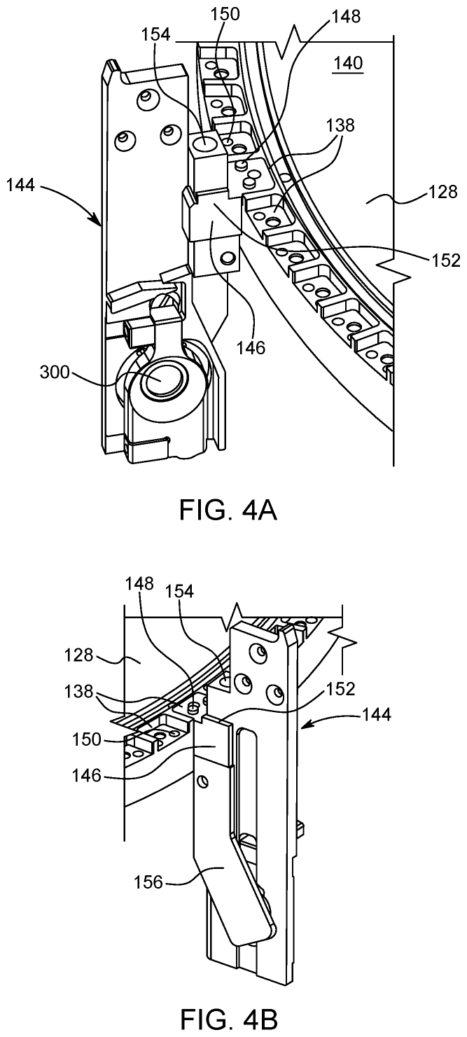

With reference to FIGS. 3 and 4A, the holding platform 128 may have a plurality of holding slots 138 extending around an outer perimeter thereof. In some examples or aspects, each holding slot 138 may be recessed into an upper surface 140 of the holding platform 128. In other examples or aspects, each holding slot 138 may protrude relative to the upper surface 140 of the holding platform 128. The plurality of holding slots 138 are desirably identical in shape and may have equal or unequal angular separation therebetween about a perimeter of the holding platform 128. In use, the holding platform 128 is configured to be indexed into a plurality of positions corresponding to the plurality of holding slots 138. For example, on a holding platform 128 having 100 holding slots 138, the holding platform 128 is configured to be indexed in angular intervals of 3.6°.

With reference to FIGS. 4A-4B, each holding slot 138 may have a cover plate 146 that is removably connectable to the respective holding slot 138. In some examples or aspects, one of the holding slot 138 and the cover plate 146 may have at least one pin 148 that is configured for being inserted into a corresponding at least one hole 150 on the other of the holding slot 138 and the cover plate 146. In other examples or aspects, the cover plate 146 may be non-removably connected or formed with the respective holding slot 138.

With continued reference to FIGS. 4A-4B, each holding slot 138 is configured for receiving a holder 144 adapted for securing an optical article 300. Each holder 144 may be removably connectable to the respective holding slots 138. For example, the holder 144 may be removably connectable to the respective cover plate 146 of each holding slot 138. In this manner, the optical article 300 (shown in FIG. 4A) may be installed onto the holder 144 prior to the start of the automated inspection process, or removed from the holder 144 at the end of the automated inspection process. Additionally, each holder 144 may be removed from the respective holding slot 138 and/or the cover plate 146 during the optical article inspection process, as described herein.

With continued reference to FIGS. 4A-4B, each cover plate 146 has a connection interface 152 configured for removably receiving the holder 144. In some examples or aspects, the connection interface 152 may be a metal surface made from a magnetic, magnetizable, or magnetically attractive material. In this manner, the holder can be removably connected to the connection interface 152 via a magnetic interaction with the cover plate 146. For example, holder 144 may have a first connection member 154 made from a magnetic, magnetizable, or magnetically attractive material that is configured for magnetically interacting with a corresponding a magnetic, magnetizable, or magnetically attractive material on the connection interface 152 of the cover plate 146.

With reference to FIG. 4B, each cover plate 146 has a baffle 156. In some examples or aspects, the baffle 156 depends downwardly from a body 158 of the cover plate 146 and is configured to block at least a portion of the optical article 300 when the holder 144 is connected to the cover plate 146. In some examples or aspects, the baffle 156 is configured to prevent water flow pressure from distorting the surface of the optical article 300 (shown in FIG. 4A). For example, the baffle 156 may be positioned relative to the optical article 300 such that water flow pressure due to movement of the holding platform 128 primarily impacts the baffle 156 instead of the surface of the optical article 300. Additionally, the baffle 156 may be configured for shielding stray light that may enter the holding chamber 114 from reaching the optical article 300. In this manner, activation of light-activated coatings on the optical article 300 is prevented.

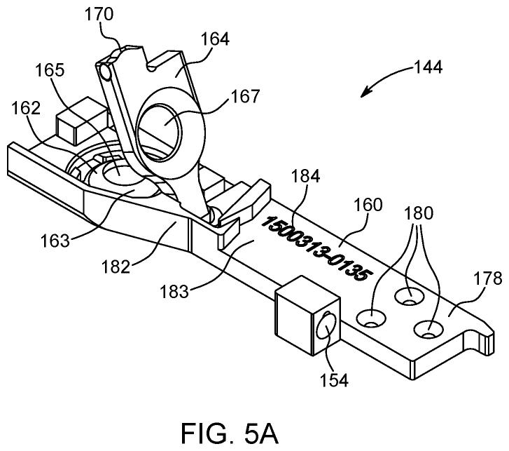

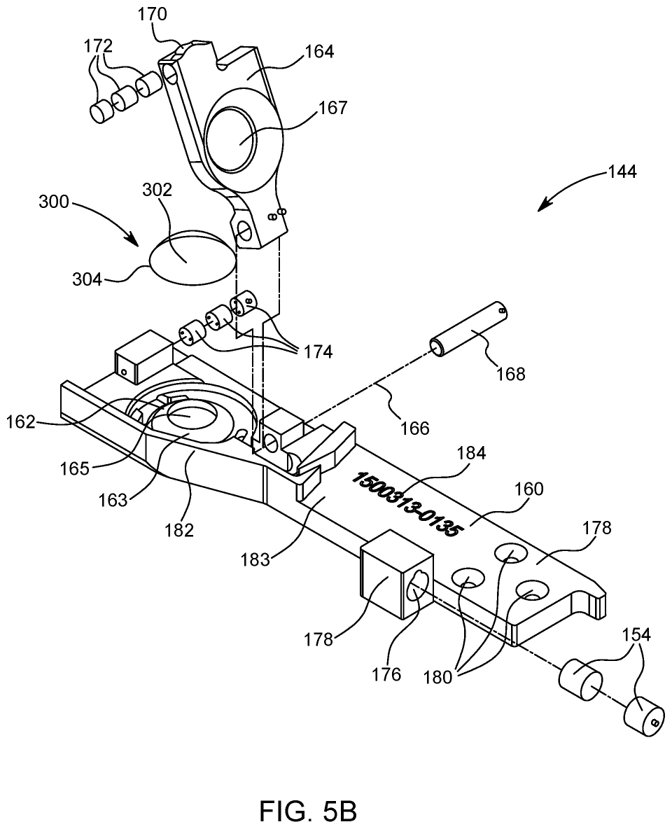

With reference to FIGS. 5A-5B, the holder 144 is shown separately from the holding platform 144. The holder 144 has a holder body 160 with an optical article (lens) receiving portion 162, and a clamping lid 164 connected to the holder body 160. The optical article receiving portion 162 may have a support surface 163 that is at least partially shaped to correspond to a shape of the optical article 300. For example, the support surface 163 may have a convex shape. In some examples or aspects, the support surface 163 may be configured to self-center the optical article 300 thereon such that the optical article 300 is positioned in a desired orientation. The support surface 163 has at least one groove 169 configured to facilitate even fluid flow over the optical article 300 during the measurement process in order to remove any air bubbles which may cause inaccuracies in the inspection process. An inspection opening 165 is provided on the support surface 163 and is configured to permit unobstructed view of at least a central portion of the optical article 300. The clamping lid 164 has a corresponding inspection opening 167 that, when the clamping lid 164 is closed, aligns with the inspection opening 165 on the holder body 160. An underside of the clamping lid 164 has a contoured surface that is shaped to correspond to the support surface 163 such that, when the clamping lid 164 is closed, the optical article 300 is held between the support surface 164 and the clamping lid 164 without distortion to the shape of the optical article 300 which may result in inaccuracies in the inspection process.

With reference to FIGS. 5A-5B, the clamping lid 164 is movably connected to the holder body 160 and is configured to be movable between a closed position, in which the optical article 300 is retained in the optical article receiving portion 162 between the holder body 160 and the clamping lid 164, and an open position, in which the optical article 300 can be removed from the optical article receiving portion 162. In some examples or aspects, the clamping lid 164 is pivotally connected to the holder body 160 and is movable about a pivot axis 166 via a pivot pin 168 (shown in FIG. 5B). The clamping lid 164 is configured to exert an even clamping pressure on the optical article 300 when the clamping lid 164 is in the closed position. The clamping lid 164 may be manually moved between the open position and the closed position via a grip 170 on a free end of the clamping lid 164.

In some examples or aspects, a locking mechanism may be provided to lock the clamping lid 164 in the closed position. For example, with reference to FIG. 5B, at least one first magnet 172 may be provided on the clamping lid 164 proximate to the grip 170 and at least one second magnet 174 may be provided on the holder body 160. The at least one first and second magnets 172, 174 are positioned such that they generate a magnetically attractive force therebetween to retain the clamping lid 164 in the closed position when the at least one first magnet 172 and the at least one second magnet 174 are in magnetic proximity to each other.

With continued reference to FIGS. 5A-5B, the holder body 160 has the first connection member 154 configured for removably connecting the holder 144 to the holding slot 138, such as the connection interface 152 of the cover plate 146 connected to the holding slot 138. The first connection member 154 may be made from a magnetic, magnetizable, or magnetically attractive material that is configured for magnetically interacting with a corresponding a magnetic, magnetizable, or magnetically attractive material on the connection interface 152 of the cover plate 146. In some embodiments or aspects, the first connection member 154 may be received in a holding cavity 176 of a receiving member 178 connected to the holder body 160 (shown in FIG. 5B).

With continued reference to FIGS. 5A-5B, the holder body 160 has a second connection member 178 configured for removably connecting the holder 144 to gripper mechanism during transport of the holder 144 from the holding platform 128 to the inspection station 104 (shown in FIG. 1). In some examples or aspects, the second connection member 178 comprises one or more through holes 180 extending through the holder body 160. For example, the second connection member 178 may have 3 through holes extending through the holder body 160. As described herein, the gripper mechanism has a corresponding number of pins that are configured to extend through the through holes 180 of the second connection member 178 to securely grip the holder 144 during transport of the holder 144 from the holding platform 128 to the inspection station 104 (shown in FIG. 1).

With continued reference to FIGS. 5A-5B, the holder body 160 has a shield 182 protruding outwardly from an upper surface 183 of the holder body 160. The shield 182 extends along at least a portion of longitudinal length of the holder body 160 and at least partially surrounds the clamping lid 164. The shield 182 is configured for shielding stray light that may enter the holding chamber 114 from reaching the optical article 300. In this manner, activation of light-activated coatings on the optical article 300 is prevented.

With continued reference to FIGS. 5A-5B, the holder body 160 has an identification tag 184. In some examples or aspects, the identification tag 184 includes identifying information about at least one characteristic of the holder 144 and/or the optical article 300. For example, the identification tag 184 may contain information about the position of the holder 144 on the holding platform 128 and/or identifying information about one or more characteristics of the optical article 300. In some examples or aspects, the identification tag 184 may be an RFID tag. The identification tag 184 may be unique to each holder 144.

With reference to FIG. 5B, the optical article 300 has a forward or top surface 302, a rearward or bottom surface (not shown), and a side surface 306 extending between the top surface 302 and the bottom surface. When the optical article 300 is a contact lens, the bottom surface is opposed to the eye of an individual wearing the optical article 300 and the top surface 302 faces incident light (not shown) at least a portion of which passes through the optical article 300 and into the individual's eye.

The optical article 300 can be selected from ophthalmic articles or elements, display articles or elements, windows, mirrors, active liquid crystal cell articles or elements, and passive liquid crystal cell articles or elements. Examples of ophthalmic articles or elements include, but are not limited to, corrective and non-corrective lenses, including single vision or multi-vision lenses, which can be either segmented or non-segmented multi-vision lenses (such as, but not limited to, bifocal lenses, trifocal lenses, and progressive lenses), contact lenses, as well as other elements used to correct, protect, or enhance (cosmetically or otherwise) vision, including without limitation, optical articles, intra-ocular lenses, magnifying lenses, and protective lenses or visors.

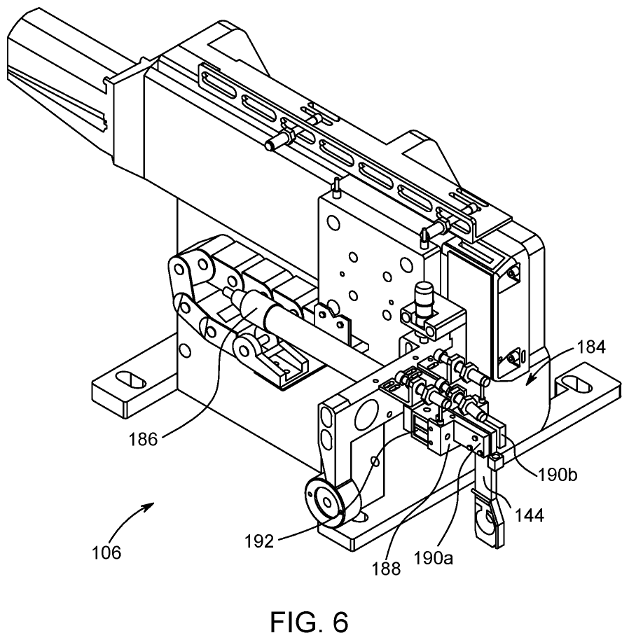

With reference to FIG. 6, the transfer station 106 is shown separately from the remaining components of the inspection apparatus 100 shown in FIG. 1. The transfer station 106 is configured for transferring a selected holder 144 from the holding station 102 to the inspection station 104 (shown in FIG. 1). In some examples or aspects, the transfer station 106 has a gripper mechanism 184 that is configured for gripping the selected holder 144 when the holding platform 128 is rotated such that the holder 144 is aligned in an inspection position. After gripping the selected holder 144, the gripper mechanism 184 may be configured for moving the selected holder 144 from the holding platform 128 to the inspection station 104 (shown in FIG. 1). After the inspection process is completed, the gripper mechanism 184 may be configured for moving the selected holder 144 from the inspection station 104 back to the same holding slot 138 on the holding platform 128 from which the holder 144 was removed.

With continued reference to FIG. 6, the gripper mechanism 184 may have an actuator 186 for moving the holder 144 between the holding platform 128 and the inspection station 104. The actuator 186 may be a linear actuator, a rotary actuator, or a combination thereof. In some examples or aspects, the actuator 186 may be configured for linearly moving between the holding platform 128 and the inspection station 104. In other examples or aspects, the actuator 186 may be configured for rotatably moving between the holding platform 128 and the inspection station 104. In further examples or aspects, the actuator 186 may be configured for linearly and rotatably moving between the holding platform 128 and the inspection station 104.

With continued reference to FIG. 6, the gripper mechanism 184 may have a gripper 188 configured for gripping the holder 144. In some examples or aspects, the gripper 188 may be configured to grip the holder 144 when the gripping mechanism 184 is positioned proximate to the selected holder 144. After gripping the holder 144, the gripper 188 may be configured to hold the holder 144 during transfer between the holding platform 128 and the inspection station 104 and during the inspection process at the inspection station 104. The gripper 188 may be configured to release the holder 144 after the gripper mechanism 184 returns the holder 144 to the holding slot 138.

In some examples or aspects, the gripper 188 may have a pair of jaws 190a, 190b operable between an engaged position and a disengaged position. In the engaged position, the jaws 190a, 190b are urged toward each other to retain at least a portion of the holder 144 therebetween. In the disengaged position, the jaws 190a, 190b are urged away from each other such that the holder 144 is released from being held between the jaws 190a, 190b. At least one of the jaws 190a, 190b may have a plurality of pins 191 that are configured for extending through the through holes 180 on the second connection member 178 of the holder 144 (shown in FIG. 5A). The jaws 190a, 190b may be movable between the engaged position and the disengaged position via a gripper actuator 192. In some examples or aspects, the gripper actuator 192 may be an electric motor, a pneumatic actuator, or a solenoid.

With reference to FIGS. 7A-7C, the inspection station 104 is shown separately from the remaining components of the inspection apparatus 100 shown in FIG. 1. The inspection station 104 is connected to the holding station 102 (shown in FIG. 7C) to allow transfer of individual holders 144 from the holding chamber 114 to the inspection station 104. The inspection station 104 includes a housing 194 having a sidewall 196 defining an inspection chamber 198. The inspection chamber 198 is configured for being at least partially filled with liquid, such as water or a saline solution. In some examples or aspects, the inspection chamber 198 is in fluid communication with the holding chamber 114 (shown in FIG. 7C).

With continued reference to FIGS. 7A-7C, the inspection chamber 198 has a transfer channel 200 connecting an inspection portion 202 to the holding chamber 114. The inspection chamber 198 has a width that is configured to accommodate the holder 144 held by the gripper mechanism 184 (shown in FIG. 6) during transfer of the holder 144 between the holding chamber 114 and the inspection chamber 198. In some examples or aspects, as shown in FIG. 7C, an inner surface 204 of the sidewall 196 of the transfer channel 200 may be scalloped to help diffuse any stray light from the inspection portion from passing into the holding chamber 114. The scalloped inner surface 204 of the sidewall 196 diffuses incident light to minimize the passage of light into the holding chamber 114. Additionally, the scalloped inner surface 204 of the sidewall 196 is configured to maximize heat transfer to the liquid inside the inspection chamber 198 to help in maintaining an accurate liquid temperature.

With reference to FIG. 7A, the inspection station 104 may have a viewing port 206 in the sidewall 196. The viewing port 206 has a transparent cover to permit viewing of the inspection chamber 198 from the outside of the housing 194 through the viewing port 206. The viewing port 206 is positioned at the inspection portion 202 such that the optical article 300 (shown in FIG. 5B) can be inspected through the viewing port 206 when the holder 144 is positioned in the inspection portion 202 using an inspection device 208 (shown in FIG. 1). In some examples or aspects, the viewing port 206 may have a pair of windows 207 having a cavity 209 therebetween that is configured for receiving heated liquid. In this manner, heat loss though the viewing port 206 is minimized in order to accurately control the temperature of the liquid inside the inspection chamber 198. A removable shield 210 may be provided on the inner surface of the sidewall 196 to block at least a portion of the optical article 300 when the holder 144 in positioned at the inspection portion 194. As shown in FIG. 7B, a temperature probe 212 extends into the inspection chamber 198 and is configured for measuring a temperature of the liquid inside the inspection chamber 198.

With reference to FIG. 1, an auxiliary portion 214 is connected to the holding station 102 and is configured for receiving equipment for temperature control and circulation of liquid through the holding station 102 and the inspection station 104. With reference to FIG. 8, the auxiliary portion 214 is shown separately from the remaining components of the inspection apparatus 100 shown in FIG. 1. The auxiliary portion 214 includes a housing 216 having a sidewall 218 defining an auxiliary chamber 220. The auxiliary chamber 220 is configured for being at least partially filled with liquid L, such as water or a saline solution. In some examples or aspects, the auxiliary chamber 220 is in fluid communication with the holding chamber 114 and the inspection chamber 198.

With continued reference to FIG. 8, the auxiliary chamber 220 has a pump 222 configured for circulating the liquid within the holding chamber and within a temperature control circuit of the inspection apparatus, as described herein. The pump 222 is connected to a first outlet 224 that is configured for delivering the pumped liquid from the auxiliary chamber 220 into the holding chamber 114. In some examples or aspects, the pump 222 is connected to a second outlet 226 that is configured for delivering the pumped liquid to a temperature control circuit 228 (shown in FIGS. 2A and 7C). In some examples or aspects, separate pumps 222 may be provided for delivering the liquid to the holding chamber 114 and the temperature control circuit 228 via the first and second outlets 224, 226, respectively. The pump 222 has a filter 230 for filtering the liquid prior to the liquid being pumped out of the auxiliary chamber 220 via the first and second outlets 224, 226. Overflow liquid from the holding chamber 114 is returned to the auxiliary chamber 220 via a first inlet 232, and overflow liquid from the temperature control circuit 228 is returned to the auxiliary chamber 220 via a second inlet 234. In some examples or aspects, a float sensor 235 and a top-off sensor 237 may be provided in the auxiliary chamber 220. The float sensor 235 and the top-off sensor 237 are configured to maintain the desired amount of liquid in the inspection apparatus 100 and prevent overfilling of any of the chambers with liquid. This arrangement permits the inspection apparatus 100 to run throughout the duration preset by the user without the need to attend to the apparatus 100 to check on the liquid levels in various chambers.

With reference to FIG. 2A, liquid pumped using the pump 220 via the first outlet 224 (shown in FIG. 8) is delivered to a first portion 236 of the temperature control circuit 228. In some examples or aspects, the first portion 236 of the temperature control circuit 228 may have one or more first flow channels 238 in a bottom plate 240 of the holding station 102 and the inspection station 104 (shown in FIG. 1). The one or more first flow channels 238 are in fluid communication with the auxiliary chamber 220 via the first inlet 232 and the first outlet 224. The bottom plate 240 connects to the bottom wall 112 of the holding chamber 114 and the bottom wall of the inspection station 104. As the liquid is circulated through the one or more first flow channels 238, heat is transferred from the liquid to the housing 108 of the holding chamber 114 and the housing 194 of the inspection chamber 198. In this manner, liquid inside the holding chamber 114 and the inspection chamber 198 is indirectly heated through the sidewall 110 of the holding chamber 114 and the sidewall 196 of the inspection chamber 198.

With reference to FIG. 7C, second portion 242 of the temperature control circuit 228 is provided on the housing 194 of the inspection station 104. In some examples or aspects, the second portion 242 of the temperature control circuit 228 may have one or more second flow channels 244 extending through the sidewall 196 of the inspection station 104. The one or more second flow channels 244 are in fluid communication with the auxiliary chamber 220 via the first inlet 232 and the first outlet 224. As the liquid is circulated through the one or more second flow channels 244, heat is transferred from the liquid to the housing 196 of the inspection chamber 198. In this manner, liquid inside the inspection chamber 198 is indirectly heated through the sidewall 196 of the inspection chamber 198.

With reference to FIG. 8, a temperature controller 246 is provided in the auxiliary chamber 220 and is configured for heating the liquid inside the auxiliary chamber 220 to a predetermined temperature. The temperature controller 246 is configured to increase the temperature of the liquid to a temperature at which an automated inspection process of the optical articles 300 can be carried out. For example, the temperature controller 246 may be configured to maintain the temperature of the liquid within +/−0.1° C. of a desired temperature setpoint. In various examples or aspects, the temperature controller 246 may be at least one of a conductive heating device, a convective heating device, or a radiative heating device. In some examples or aspects, the temperature controller 246 may be configured to cool the liquid inside the auxiliary chamber 220. For example, the temperature controller 246 may be a thermo-electric heating/cooling device that is capable of heating or cooling the liquid inside the auxiliary chamber 220.

With reference to FIG. 1, the inspection apparatus 100 has at least one control device 250 operatively connected to at least one component of the holding station 102, the inspection station 106, and/or the transfer station 108. In some examples or aspects, a single control device 250 may be configured to control at least one component of the holding station 102, the inspection station 106, and/or the transfer station 108. In other examples or aspects, separate control devices 250 may be provided for each of the holding station 102, the inspection station 106, and the transfer station 108.

The at least one control device 250 may be configured to control at least one of operation of the drive mechanism 134 for rotating the holding platform 128, operation of the actuator 192 of the gripper mechanism 184, operation of the gripper actuator 192 for operating the jaws 190a, 190b, operation of the pump 222, and operation of the temperature controller 246. In some examples or aspects, the at least one control device 250 may be configured for operating on a 110V or a 220V AC power circuit, and/or on battery power. In other examples or aspects, the at least one control device 250 may be configured for operating on a 12V DC power circuit.

In some examples or aspects, the at least one control device 250 may be a microprocessor controller. The at least one control device 250 may be configured for pulse width modulated (PWM) operation, wherein analog operation of at least one of the drive mechanism 134, the actuator 192 of the gripper mechanism 184, gripper actuator 192 for operating the jaws 190a, 190b, the inspection device 208, the pump 222, and the temperature controller 246 can be achieved using digital control signals. In some examples or aspects, the at least one control device 250 may be configured for continuously modulated control of at least one of the drive mechanism 134, the actuator 192 of the gripper mechanism 184, gripper actuator 192 for operating the jaws 190a, 190b, the inspection device 208, the pump 222, and the heat exchanger 246. The at least one control device 250 may have memory configured for storing one or more predetermined automated inspection processes, as discussed herein.

With continued reference to FIG. 1, the inspection apparatus 100 has at least one user input device 252 configured for inputting user commands to control the operation of at least one of the drive mechanism 134, the actuator 192 of the gripper mechanism 184, gripper actuator 192 for operating the jaws 190a, 190b, the inspection device 208, the pump 222, and the temperature controller 246. The user input device 252 may include one or more devices capable of receiving information or input from the user. For example, the user input device 252 may include one or more buttons or switches 254. Alternatively or additionally, the user input device 252 may include one or more computing devices having an electronic visual display capable of displaying a graphical user interface (GUI), such as one or more monitors, touchscreens, or the like. Further, the user input device 252 may include or be in communication with one or more input devices capable of receiving input such as a touch screen display, a keyboard, a keypad, a mouse, a button, a switch, and/or the like. In some examples or aspects, the user input device 252 may be a remote device that is configured for wireless or wired communication with the inspection apparatus 100. For example, the user input device 252 may be a remote computer device or mobile phone having an application configured for wireless communication (e.g. Wi-Fi, Bluetooth, or the like) or wired communication (e.g. Ethernet cable) with the inspection apparatus 100.

In examples where the user input device 154 includes an electronic visual display, such visual display can be configured for receiving user input for controlling the operation of at least one of the drive mechanism 134, the actuator 192 of the gripper mechanism 184, gripper actuator 192 for operating the jaws 190a, 190b, the inspection device 208, the pump 222, and the temperature controller 246, and for communicating status information about an operating status or condition of the operation of at least one of the drive mechanism 134, the actuator 192 of the gripper mechanism 184, gripper actuator 192 for operating the jaws 190a, 190b, the inspection device 208, the pump 222, and the temperature controller 246. For example, the user input device 252 may be an LCD touchscreen used to input commands to control operation of at least one of the drive mechanism 134, the actuator 192 of the gripper mechanism 184, gripper actuator 192 for operating the jaws 190a, 190b, the inspection device 208, the pump 222, and the temperature controller 246. Furthermore, the user input device 252 that is configured as an LCD touchscreen may provide information regarding the operating status or condition of at least one of the drive mechanism 134, the actuator 192 of the gripper mechanism 184, gripper actuator 192 for operating the jaws 190a, 190b, the inspection device 208, the pump 222, and the temperature controller 246.

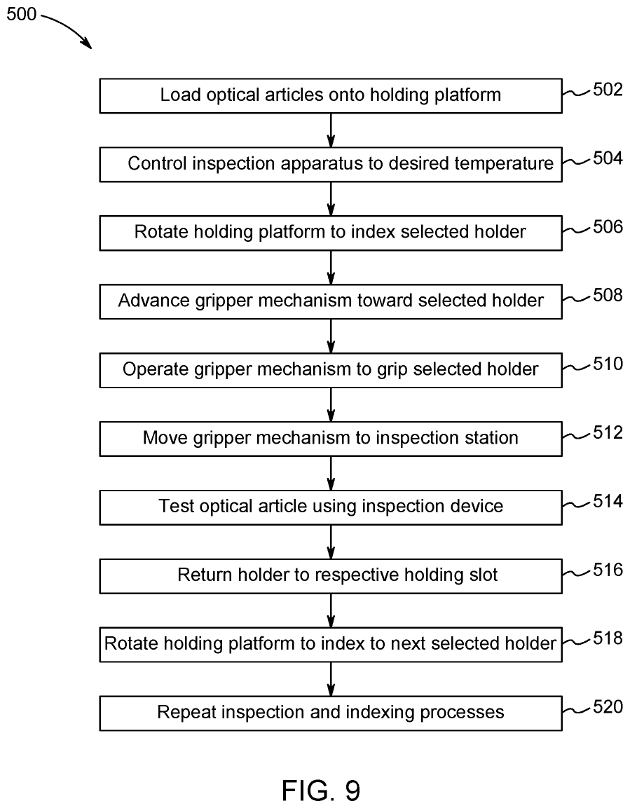

Having described the inspection apparatus 100 with reference to FIGS. 1-8, an exemplary method 500 of using the inspection apparatus 100 to inspect a plurality of optical articles, such as the optical article 300 described herein, will now be described with reference to FIG. 9. In some examples or aspects, the inspection apparatus 100 may be operated to perform one or more inspection processes on each of the plurality of optical articles 300. In this manner, a plurality of optical articles can be inspected in a batch processes.

At step 502, a plurality of optical articles 300, such as one or more contact lenses, are loaded onto the holding platform 128 that is received within the holding chamber 114 of the holding station 102. For example, each optical article 300 may be loaded into the holder 144, and the holders 144 having the optical articles 300 are then loaded into respective holding slots 138 of the holding platform 128. As described herein, the holders 144 may be magnetically connected to the respective holding slots 138 of the holding platform 128.

After loading the optical articles 300 into the holding station 102, at step 504 the liquid in the holding chamber 114 and the inspection chamber 198 is heated to a predetermined temperature and the temperature of the liquid is maintained using the temperature controller 246 and the pump 222.

Once the predetermined temperature is reached, the automated inspection process for inspecting the plurality of optical articles 300 is started. Initially, at step 506, the holding platform 128 is rotated via the drive mechanism 134 until a selected holder 144 is indexed to an inspection position. In some examples or aspects, the inspection position may be proximate to the inspection station to facilitate transfer of the holder 144 from the holding platform 128 to the inspection station 104.

At step 508, the gripper mechanism 184 is advanced toward the selected holder 144 such that gripper mechanism 184 is aligned with the selected holder 144. At step 510, the gripper mechanism 184 is operated to grip the selected holder 144. For example, the jaws 190a, 190b may be operated via actuation of the gripper actuator 192 to engage the second connection member 178 of the holder body 160. The plurality of pins 191 on one of the jaws 190a, 190b are extend through the through holes 180 on the second connection member 178 of the holder 144 to accurately position the holder 144 with respect to the gripper mechanism 184.

At step 512, the gripper mechanism is moved from the inspection position to the inspection station 104. In some examples or aspects, movement of the gripper mechanism 184 away from the holding platform 128 disengages the magnetic connection between the holder 144 and the respective holding slot 138 on the holding platform 128. The gripper mechanism 184 is configured to move the selected holder 144 from the holding slot 138 on the holding platform 128 to the inspection portion 202 within the inspection chamber 198.

At step 514, the holder 144 is positioned in the inspection station 104 such that the optical article 300 may be tested using the inspection device 208. In some examples or aspects, the inspection device 208 is configured to test at least one optical characteristic of the optical article 300.

After completion of the inspection process, the holder 144 is returned to its respective holding slot 138 at step 516. For example, the gripper mechanism 184 is moved from the inspection station 104 toward the inspection position at the holding platform 128. In some examples or aspects, as the gripper mechanism 184 is positioned proximate the holding slot 138 of the selected holder 144, the magnetic connection between the holder 144 and the respective holding slot 138 on the holding platform 128 is established and the gripper mechanism 128 can release the holder 144.

At step 518, the holding platform 128 is indexed to the next selected holder 144 so that the gripper mechanism 184 can grip the next selected holder 144 and transfer it to the inspection station 104 for inspection. The indexing and inspection processes of steps 506-518 are repeated at step 520 until all optical articles 300 on the holding platform 128 have been inspected. The inspection process then terminates and the inspected optical articles 300 can be removed from the inspection apparatus 100.

It will be readily appreciated by those skilled in the art that various modifications, as indicated above, may be made to the disclosure without departing from the concepts disclosed in the foregoing description. Accordingly, the particular examples or aspects described in detail herein are illustrative only and are not limiting to the scope of the disclosure, which is to be given the full breadth of the appended claims and any and all equivalents thereof.

1. An inspection apparatus configured for inspecting optical articles, the inspection apparatus comprising:
an inspection chamber comprising an inspection station;
a holding chamber having an indexable holding platform with a plurality of holding slots each configured for receiving a holder adapted for securing the optical article, the indexable holding platform configured to index a selected holder into an inspection position; and
a gripper mechanism configured for transferring the selected holder from the inspection position to the inspection chamber

2. The inspection apparatus according to claim 1, wherein each holder comprises:
a holder body having a lens receiving portion,
a clamping lid connected to the holder body and movable between a closed position configured for clamping the optical article and an open position; and
a first connection member configured for securing the holder body to the holding slot of the indexable holding platform.

3. The inspection apparatus according to claim 1, wherein the first connection member is one of a first magnet and a first magnetically attractable material that is configured for magnetically interacting with a corresponding one of a second magnetically attractable material and a second magnet on the holding slot of the indexable holding platform.

4. The inspection apparatus according to claim 3, wherein each holder comprises a second connection member configured for connecting the holder body to the gripper mechanism.

5. The inspection apparatus according to claim 1, wherein each holder further comprises an identification tag.

6. The inspection apparatus according to claim 1, wherein the indexable holding platform is a rotary magazine comprising a plurality of distinct circumferential positions each having a holding slot.

7. The inspection apparatus according to claim 1, wherein each holding slot of the holding mechanism comprises a baffle positioned relative to the holder such that the baffle covers the optical article.

8. The inspection apparatus according to claim 1, wherein the gripper mechanism is linearly movable between a first position corresponding to a location of the inspection position of the indexable holding platform and a second position corresponding to a location of the inspection station.

9. The inspection apparatus according to claim 1, wherein the inspection station comprises at least one viewing port and wherein the inspection chamber has a scalloped sidewall.

10. The inspection apparatus according to claim 1, further comprising an auxiliary chamber having:
a pump configured for circulating fluid within the holding chamber and within a temperature control circuit of the inspection apparatus;
a filter configured for filtering the fluid; and
a temperature controller configured for controlling a temperature of the fluid.

11. The inspection apparatus according to claim 1, wherein the holding chamber is in fluid communication with the inspection chamber.

12. The inspection apparatus according to claim 1, wherein the holding chamber is optically isolated from the inspection chamber.

13. A method of inspecting an optical article using an inspection apparatus, the method comprising:
rotating the indexable holding platform comprising a plurality of holding slots each configured for receiving a holder adapter for securing the optical article until a selected holder is indexed to an inspection position;
moving a gripping mechanism to the inspection position to grip the selected holder; and
moving the gripping mechanism from the inspection position to an inspection station configured for inspecting the optical article.

14. The method according to claim 13, further comprising returning the selected holder to the indexable holding platform after inspecting the optical article and rotating the indexable holding platform until a next selected holder is indexed to the inspection position

15. The method according to claim 13, further comprising maintaining a temperature of a fluid immersing the holders at a predetermined temperature.
